(19) United States
(12) Patent Application Publication
(10) Pub. No.: US 2026/0352637 A1
(43) Pub. Date: Nov. 5, 2026

(54) NOTIFICATIONS OF HEALTH AND STATUS INFORMATION TO EXTERNAL USERS AND INTERNAL USERS

(71) Applicant: ViaSat, Inc., Carlsbad, CA (US)

(72) Inventors: Gregory R. Jay, Carlsbad, CA (US); Ryan C. Denner, Carlsbad, CA (US)

(73) Assignee: ViaSat, Inc., Carlsbad, CA (US)

(21) Appl. No.: 19/150,894

(22) PCT Filed: Jan. 24, 2024
(86) PCT No.: PCT/US2024/012797

§ 371 Date: Jul. 24, 2025

Related U.S. Application Data
(60) Provisional application No. 63/481,603, filed on Jan. 25, 2023.

(51) Int. Cl. H04L 9/40

(52) U.S. Cl. CPC H04L 63/0272; H04L 63/0281

(57) ABSTRACT

The method may include gathering status check data from components at a time interval respectively associated with each of the components; storing the status check data in a private cluster; triggering status notifications for each of the plurality of components, in response to a status change of the status check data of any of the plurality of components; acquiring user data associated with one or more External Users that requested the status notifications; filtering the status notifications for a subset of the plurality of components, based on a Status Proxy in a public cluster; providing the status notifications for the subset of the plurality of components in a user interface to the one or more External Users that have access to the public cluster; and providing the status notifications for the plurality of components in the user interface to Internal Users that have access to a private cluster.

### CROSS-REFERENCE TO RELATED APPLICATIONS

This application claims priority to, and the benefit of, U.S. Ser. No. 63/481,603 filed on Jan. 25, 2023 and entitled “Insights Status Architecture and Functionality,” which is hereby incorporated by reference for all purposes in its entirety.

### FIELD This application generally relates to status notifications, and more particularly, to providing notifications of component health and status information to external users and internal users.

### BACKGROUND

Many industries rely on the uninterrupted and reliable operation of various systems and components. However, it is inevitable that certain components may fail, become disconnected or otherwise become impaired. To deal with such inevitable problems, a company may often have back-up plans where it can re-route data or use alternative servers. In that regard, the company often prefers to not be surprised by such interruptions to services and the company prefers to receive prompt notifications of any such interruptions to services.

Moreover, the system monitoring such interruptions may need to provide such notifications to internal users and external users. In that regard, the system may provide more detailed information to internal users and filtered information to external users. Furthermore, such external users may prefer to receive notifications that are only relevant to their particular industry or business. As such, a strong need exists to provide different notifications of the health and status information for various components to internal users and external users.

### SUMMARY

In various embodiments, as set forth in FIG. 6, an exemplary method may include gathering status check data from each of a plurality of components at a time interval respectively associated with each of the plurality of components (step 605); storing the status check data in a private cluster (step 610); triggering status notifications for each of the plurality of components, in response to a status change of the status check data of any of the plurality of components (step 615); acquiring user data associated with one or more External Users that requested the status notifications (step 620); filtering the status notifications for a subset of the plurality of components, based on a Status Proxy in a public cluster (step 625); providing the status notifications for the subset of the plurality of components in a user interface to the one or more External Users that have access to the public cluster (step 630); and providing the status notifications for the plurality of components in the user interface to Internal Users that have access to a private cluster (step 635).

In various embodiments, the storing the status check data may further comprise caching and synchronizing the status check data. In various embodiments, the providing the status notifications to the one or more External Users may further comprise creating one or more user browser tokens respectively for the one or more External Users, in response to the one or more External Users requesting the status notification; storing the one or more user browser tokens in a cloud database; obtaining the one or more user browser tokens from the cloud database; and transmitting the one or more user browser tokens respectively to a browser associated with the one or more External Users, wherein the browser allows the status notifications to be included in a pop-up window on the user interface.

In various embodiments, the providing the status notifications to the one or more External Users may include providing the status notifications as background status notifications to the one or more External Users that registered for the background status notifications, wherein the background status notifications appear regardless of an app being open. The background status notifications may be browser notifications. The method may further comprise installing a service worker configured to provide the status notifications as the background status notifications. The method may further comprise filtering the status changes to include the status changes that are relevant to the one or more External Users. The method may further comprise handling hypertext transfer protocol (HTTP) requests using a display thread. The method may further comprise reading the status check data in storage and new incidents in storage, prior to displaying the status check data and the new incidents, in response to HTTP requests. The gathering the status check data may use one or more status check threads.

In various embodiments, the method may further comprise checking, after the time interval, if each of the plurality of components should run a status check based on a respective last check timestamp on each of the plurality of components. The method may further comprise updating a last check timestamp on each of the plurality of components, in response to running a status check on a respective each of the plurality of components. The providing the user interface may be in response to the one or more External Users within the public cluster having subscriptions for the user interface. The user interface may include the status notifications obtained from the private cluster using JavaScript Object Notation (JSON). The storing the status check data in the private cluster may include storing the status check data in a Remote Server and in a cloud server for long term storage. The providing the status notifications to the one or more External Users may include providing the status notifications in a foreground browser notification, in response to the one or more External Users having an app open. Each of the status notifications may include a navigation option to access a status page. Each of the status notifications may include a navigation option to access an incidents page.

### BRIEF DESCRIPTION OF THE DRAWINGS

The subject matter of the present disclosure is particularly pointed out and distinctly claimed in the concluding portion of the specification. A more complete understanding of the present disclosure may be obtained by referring to the detailed description and claims when considered in connection with the drawing figures, wherein like numerals denote like elements. Each of the various Figures and components may be in accordance with various embodiments of the disclosure.

FIG. 1 is an exemplary status notification page for an Internal User with error-free status indicators for general components and sub-components, in accordance with various embodiments.

FIG. 2 is an exemplary status notification page for an Internal User indicating one or more errors associated with the general components and the option to show the sub-components, in accordance with various embodiments.

FIG. 3 is an exemplary status notification page for an External User indicating one or more errors with the general components, in accordance with various embodiments.

FIG. 4 is any user interface showing an exemplary notification status of one or more errors and options to navigate to a status notification page (as set forth in FIGS. 1-3) or an incidents page, in accordance with various embodiments.

FIG. 5 is an exemplary software architecture and data/query flow, in accordance with various embodiments.

FIG. 6 is a flowchart of an exemplary process, in accordance with various embodiments.

### DETAILED DESCRIPTION

In various embodiments, a system may monitor and/or check the status of various modules of the system or components with which the system communicates. As used herein, “modules” may describe the software architecture and “components” may describe the applications that are monitored. For example, the system monitors multiple incidents and/or occurrences of an incident (e.g., what went wrong) and provides notifications based thereon. In various embodiments, the system provides notifications of incidents, component health, and/or component status information to External Users 545 and/or Internal Users 540. As used herein, the term “user” may include a person, system and/or computer. An Internal User 540 may include a system administrator that controls the modules and monitors the components. An External User 545 may include a customer of the system administrator and/or an entity that operates certain components. The components may include, for example, services, applications, webpages, websites, web applications, web services, databases, data pipelines, data tables, charts, single sign on, managers, controllers, payment services, configurators, airflows, usage monitors, etc. The components may include one or more sub-components.

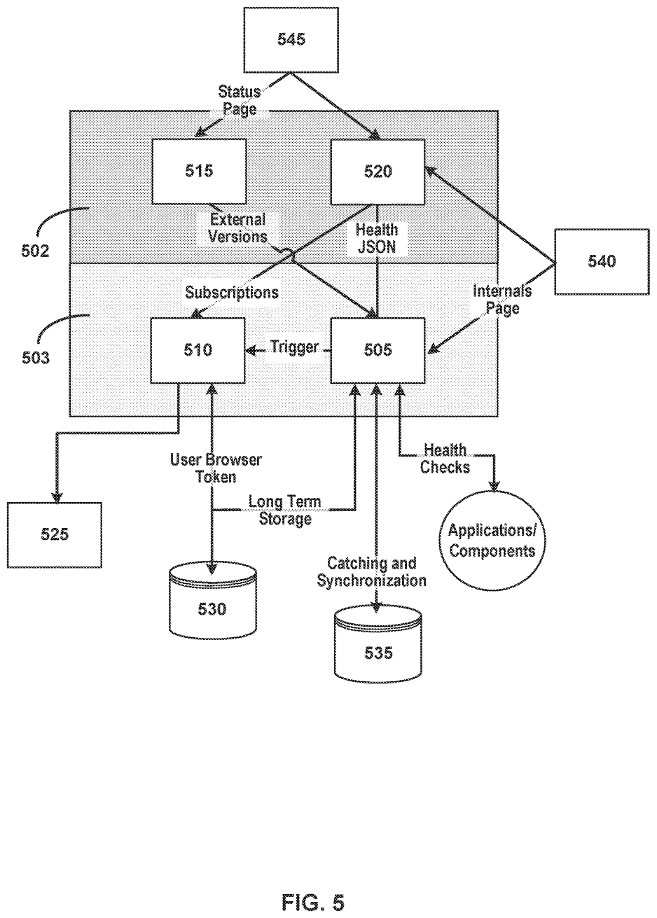

The system may include various modules, including the modules shown in FIG. 5, that may include microservices. In various embodiments, the modules include one or more of a Status Gatherer 505, a Notifications module 510, a Status Proxy 515 module, a web application console 520, a Browser Notifications Service 525, a Database (e.g., data cloud) 530 storage, a Remote Server 535, an Internal User 540 and/or an External User 545. While each of the components may be described as performing certain functions, the system contemplates that any of the components may perform some of all of the functions set forth herein. Moreover, while each of the components may be described as interfacing with other components, the system contemplates that any component may interface with any other component. The modules may communicate with each other with different interfaces. The modules may be configured for high availability. The modules may be hosted in the cloud. The Notification module 510 may alert the users that a problem exists and confirm that the problem is being handled (e.g., by a third party).

In various embodiments, the modules may be in different containers and/or clusters. The modules may be controlled, deployed and/or scaled by a container and/or cluster management service. For example, the system may use Amazon Elastic Kubernetes Service (EKS). EKS is a cloud-based container management service that natively integrates with Kubernetes to deploy applications. The EKS service may automatically manage and scale clusters of infrastructure resources on Amazon Web Services (AWS) with Kubernetes. In various embodiments, the clusters may include a public cluster 502 and a private cluster 503. The public cluster 502 may be accessible via any public network such as the internet. The private cluster 503 may not be fully or partially publicly accessible. In various embodiments, the public cluster 502 may interface with the private cluster 503 and/or may include a Status Proxy 515 module and a web application console 520 (as further described below). In various embodiments, the private cluster 503 may include a Notifications module 510 and a Status Gatherer 505. An External User 545 may access the private cluster 503 data using a virtual private network (VPN) or by going through the Status Proxy 515 module or the web application console 520.

To allow the Status Gatherer 505 to be highly available, in various embodiments, the Status Gatherer 505 may be multi-threaded. For example, the Status Gatherer 505 may include one or more status check threads (e.g., that run a status check on one or more components of the system to identify any incidents related to a respective one of the one or more components) and/or one or more display threads (e.g., that display results and incidents from the status check) for handling HTTP requests. Thus, the Status Gatherer 505 may use the status check thread(s) to obtain status check results or data from the component(s) and use the display thread(s) to report results of the status check. In some embodiments, a software instance (e.g., of the Status Gatherer 505) may be running to perform a status check. The status check, performed by the status check thread, may run every time period (e.g., every minute). For example, the status check thread may check a timer or clock to monitor a time period and determine if the Status Gatherer 505 should run a status check on one or more components. A last check timestamp (e.g., in the Remote Server 535) may identify when the status check was last performed and be used to determine if a particular software instance (e.g., of the Status Gatherer 505) may be able to run the status checks by determining if a certain time period has passed since the last status check. After the Status Gatherer 505 starts running the status check, the Remote Server 535 may update the last check timestamp. After the status check is complete, the results of the status check and any new incidents may be written and saved to the Remote Server 535. For long term storage, Status Gatherer 505 may save any new incidents to the Database 530. In some instances, this includes saving details of the specific incidents that occurred. The display threads of the Status Gatherer 505 may read the status check results and incidents from the Remote Server 535, prior to displaying the status check results and incidents.

In various embodiments, the Status Gatherer 505 may be an HTTP server. The Status Gatherer 505 may interface with the Status Proxy 515 module. The Status Gatherer 505 may provide the Status Proxy 515 module with an HTML result in a user interface (e.g., webpage, dashboard, web portal, etc.). External User 545 may communicate with (e.g., read or request data from) Status Proxy 515 module or web application console 520 via HTML, really simple syndication/rich site summary (RSS) and/or access to memory (ATOM). Internal User 540 may communicate with Status Gatherer 505 via HTML, RSS and/or ATOM. Status Proxy 515 module may communicate with Status Gatherer 505 via JSON. The Status Gatherer 505 may provide the status check data to the web application console 520. For example, the Status Gatherer 505 may receive a query from the web application console 520 that may use a Health JSON to interface with Status Gatherer 505. The JSON is an open standard file format and data interchange format that uses human-readable text to store and transmit data objects consisting of attribute-value pairs and arrays. In response to a change in status check data, the Status Gatherer 505 may send a trigger to the Notifications module 510.

With respect to incidents, for example, the Status Gatherer 505 may conduct a status check for a commercial aircraft incident (e.g., outage) every 1 minute. Such a status check may comprise querying a table of open cases that meet one or more conditions or querying equipment on or associated with the commercial aircraft directly for open cases, wherein each case may have a priority level (e.g., P1 or P2), status and/or type. The conditions may include, for example, not closed, resolved/recovered, priority of level 1 or level 2, not a weather event, created within a time period (e.g., last 14 days), etc.

In various embodiments, the system may conduct different types of status checks and/or conduct those status checks at different frequencies (also referred to as periods). The frequencies provided are merely examples and may be adjusted to optimize the system performance. For example, the Status Gatherer 505 may conduct a status check (e.g., every 1 minute) and return data about the status of a component or tool (e.g., an open source software (OSS) tool used for data pipeline orchestration). An incident for the OSS tool may comprise the system not receiving some data because the OSS tool is not functioning, etc. In some embodiments, the. Status Gatherer 505 may conduct a status check by querying one or more of the components (e.g., every 1 minute) by using application configuration information from the database (e.g., to verify that each component is working). The application configuration information may refer to obtaining the list of components to query by the status checker. The status check data based on the conducted status check may be saved in the Status Gatherer 505. The Status Gatherer 505 may conduct a status check of web application console 520 every 1 minute by querying the hotel URL for a status. The Status Gatherer 505 may conduct a status check of payment services every 1 minute by querying an application programming interface (API) for the status of the payment services. The Status Gatherer 505 may conduct a status check of the RMQ status every 5 minutes by querying cloud metrics for the number of messages processed in the last 5 minutes and then comparing the number of messages processed to the threshold for that particular environment. The Status Gatherer 505 may conduct a status check of the Database 530 status every 10 minutes by returning data with the health of all database instances and then filtering to an instance of a cloud data center. The Status Gatherer 505 may conduct a status check of the single sign on component status every 1 minute by querying for a valid HTTP status. The Status Gatherer 505 may conduct a status check of the table statuses every 5 minutes by performing one or more queries. The queries may include, for example, a status push query, a mobility manager query for a particular region having a location data table with a filter for a particular airline or an HTTP availability query for a particular region having an availability table with a filter for a particular airline.

The Status Gatherer 505 may gather data from various components. In various embodiments, to add a new component to the routine, the Status Gatherer 505 may create an applicable interface (query or connection) to facilitate gathering data from the new component. In that regard, the Status Gatherer 505 is scalable and extendable in that additional interfaces (e.g., representational state transfer (REST) interfaces) can be easily added for new components. The Status Gatherer 505 may associate with the new component and a time period for determining when a status check should be sent to the new component. The Status Gatherer 505 may associate with the new component, a display configuration (e.g., how the new component will be displayed on the status page). In various embodiments, the Status Gatherer 505 may also determine how to display the icon for the new component. The Status Gatherer 505 may also gather data from various components by using an appropriate API protocol for each of the components. The Status Gatherer 505 may gather data from various components by using an appropriate Query Database function for certain time periods (e.g., 1-5 minutes).

In various embodiments, the system may also allow the user to receive status check feeds. By using the status check feeds, the user does not need to go to a webpage or app to obtain the results of the status checks. The status check feeds may be an HTML form of feeds. The user may obtain feeds using a feed reader to query and get the status feeds.

In various embodiments, the Status Gatherer 505 may confirm that the component is running properly. In particular, the Status Gatherer 505 may create an extension to check the stature of each component and create an interval with a name. The system uses a software framework, for example, in Typescript/Javascript +NodeJS, for adding a new status checker by providing how frequent, what to call it both internally and externally to display on the UI, and the steps to perform the check. The new status checker may register itself at start up. The Status Gatherer 505 may determine if the component (e.g., database or table) received a certain number or threshold of new records in a certain time period (e.g., the last 5 minutes) to help determine that the data is recent and accurate, and that the component is active. In various embodiments, the Status Gatherer 505 may review the “health end point” (or alive end point) of a component. The health end point provides the status or health of the component. Such a health end point is typically used by the component for self-healing. The component may return a message to the Status Gatherer 505 indicating that the component is active, so the Status Gatherer 505 presumes the component is working properly. If the component does not provide a return message, then the Status Gatherer 505 presumes the component has a problem and/or is not working correctly and stores incidence data of such an incident.

In various embodiments, when the Status Gatherer 505 checks the status of a data table, the Status Gatherer 505 may confirm that the tables have been continuously updated. For example, a data table may include location data of an aircraft. If the Status Gatherer 505 determines that the table was not updated for a period of time (e.g., because the location data of the aircraft remains constant or relatively constant for a duration of time), then the Status Gatherer 505 may determine that there is a problem, which could be the result of the aircraft network being broken, the system that populates the database being broken, etc.

The Status Proxy 515 module may receive a request from an External User 545 by which the External User 545 requests status information. In various embodiments, the Status Proxy 515 module may gather status check data about status checks from different components over relevant intervals. The Status Proxy 515 module may interface with an HTTP server such as the Status Gatherer 505. The Status Proxy 515 module may obtain an HTML result in a user interface (e.g., webpage, dashboard, web portal, etc.) from the Status Gatherer 505. In various embodiments, the Status Proxy 515 module may create an external version of the webpage by filtering out certain components (and filtering out the status of those components) that may not be relevant to the particular External User 545. For example, the Status Proxy 515 module may remove maritime status check data from a webpage that is created for a business aviation user. The Status Proxy 515 module may provide the HTML result (e.g., in the form of a status page) to the External User 545. The results may be provided by the Notifications module 510 in the foreground and/or background (as further explained herein). An Internal User 540 may view the resulting webpage on or via a virtual private network (VPN). The Status Proxy 515 module may store data locally and/or may store data within a Remote Server 535. The Remote Server 535 may provide caching and synchronization of the data.

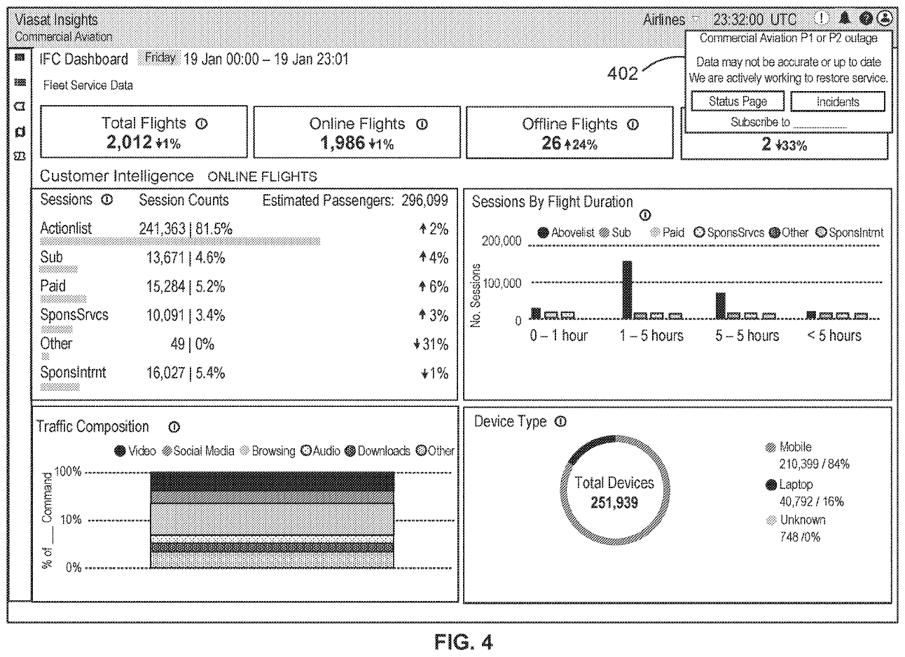

In various embodiments, the web application console 520 may include an application infrastructure, wherein multiple web applications can be plugged into the web application console 520 and the web applications can leverage the underlying services. The use of the term “web application console” is an analogy of each web application having its own “area” in the web application console 520, such that the status check data is available to all of the web applications. The web application console may include a container or application, that can host multiple applications accessible through a single interface. The system may add a new web application (on another floor of the web application console 520) and the status check data is available to such new web application. The web application console 520 may receive a request from an External User 545 or an Internal User 540. The web application console 520 may also receive a request from an Internal User 540. Based upon the received request, an elapsed time since a previous status check, a trigger, etc., the web application console 520 may query the Status Gatherer 505 to obtain the status check data for any of the applications. The web application console 520 may query the Status Gatherer 505, for example, by using a Health JSON to interface with Status Gatherer 505. The web application console 520 may provide the results from the Status Gatherer 505 in a webpage to External Users 545 (e.g., FIG. 4 notification) or to any other applications in a corresponding format. The results may be provided by the Notifications module 510 in the foreground and/or background (as further explained herein).

In various embodiments, the status of some of the components may be available to External Users 545, but the status of sub-components may only be available to Internal Users 540. The components (or web applications) may be user specific, region specific or function specific. For example, the components that may be provided may include Business Aviation and Commercial Aviation. The system may use components for a status check of the database, then display what it is internally, but mask it externally. The system may query a database (e.g., Snowflake) status every 5 minutes.

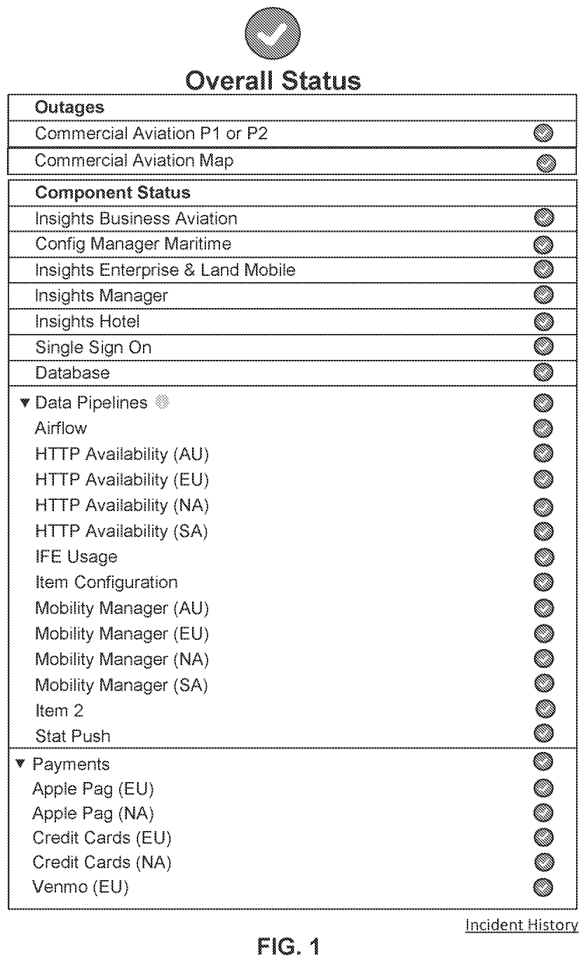

The Notifications 510 module may provide notifications about the status and/or health of one or more components. In various embodiments, as set forth in FIGS. 1-3, the notification may show each component with an indicator (e.g., graphic), wherein the indicator may change or otherwise provide an indication, depending on the status of the component. FIG. 1 is an exemplary status notification page for an Internal User 540 with error-free status indicators for general components and sub-components, in accordance with various embodiments. The status notification page may include various sections, including an “Outages” section and a “Component Status” section, and each status is indicated with a corresponding graphic. The graphic (e.g., circle) may include an indication (e.g., different color, flashing, symbol change, etc.) that shows whether the corresponding component has an outage. The Outages section may provide a graphic that indicates an outage anywhere within the network and/or an outage has been reported to the system. The Outages section may describe high order issues in the network that cannot be attributed to a single component in the ground based system but are causing issues for customers. The outage status for “Commercial Aviation P1 or P2” may be input by support and be displayed, as set forth in FIGS. 1-3. Priority 1 (P1) and Priority 2 (P2) indicate the severity of the network issue, problem and/or outage. For example, P1 may be an issue impacting all users, while P2 may be an issue impacting a subset of users. An event may be an active issue causing the P1 or P2 issue. The system may experience more than one active issue at a time. The “Commercial Aviation” component may relate to passenger-based services. The “Commercial Aviation Pl or P2” component may monitor passengers trying to get onto a service, wherein the outage could be anywhere in the network and reported by the network. The “Commercial Aviation Map” component (also known as “red map alert”) may include a monitoring map (e.g., in real-time) that includes a collection of problems from components in the Component Status section and possibly other events that may occur that could cause an outage. The “Commercial Aviation Map” may indicate an outage in response to several components indicating problems.

With respect to FIGS. 1-3, the components may include Config Manager Maritime, Dispatcher, Enterprise and Land Mobile and Manager. Other components may include Maritime, web application console 520 and Single Sign On. Some components may include status for services that ingest reporting analytics data into the database. Details may be provided internally, but the details are hidden externally. Such components may include Database, Data Pipelines, and Payments. Service Manager for Business Aviation may be another provided component. For Internal Users 540 (users), additional sub-components of data pipelines may be available such as, for example, an OSS tool to orchestrate data pipelines, HTTP availability (AU), HTTP availability (EU), HTTP availability (NA), and HTTP availability (SA). The components may provide different data feeds to report on the service. The components may check that data continues to be received in a near real time manner. Such components may include, for example, IFE Usage, LRU Configuration, Mobility Manager (AU), Mobility Manager (EU), Mobility Manager (NA), Mobility Manager (SA), RMQ and Stat Push. For Internal Users 540 (users), additional sub-components of payments may be available such as, for example, Apple Pay (EU), Apple Pay (NA), Credit Cards (EU), Credit Cards (NA), Venmo (EU), etc.

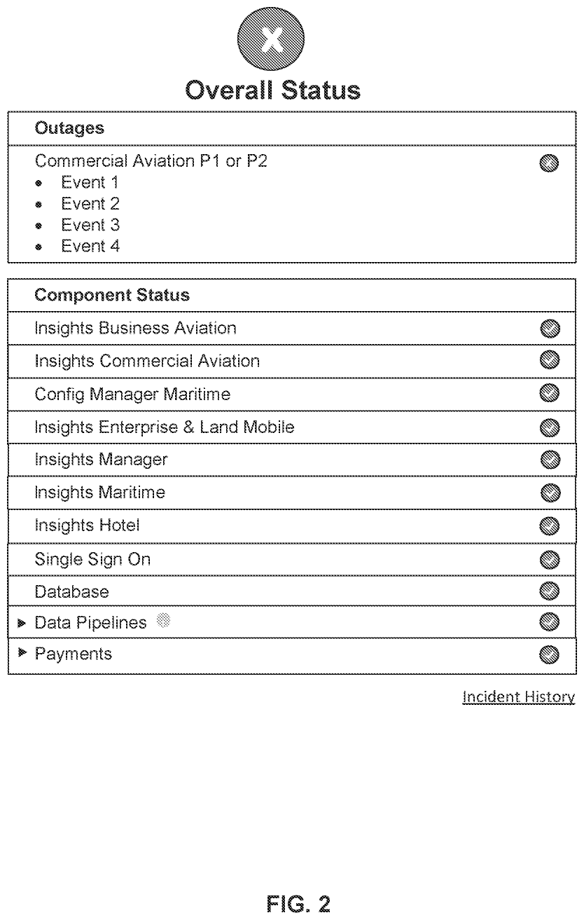

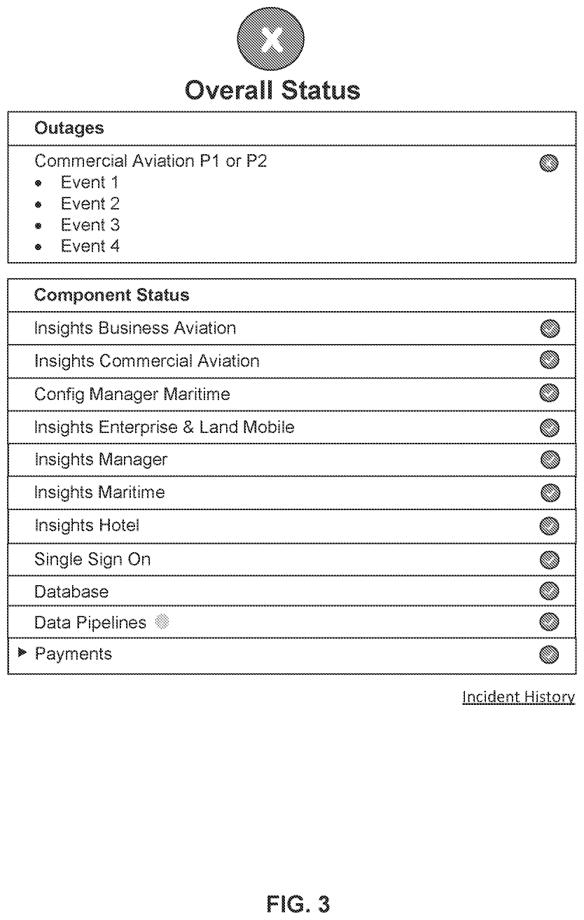

FIG. 2 is an exemplary status notification page for an Internal User 540 indicating one or more errors associated with the general components and the option to show the sub-components, in accordance with various embodiments. FIG. 3 is an exemplary status notification page for an External User 545 indicating one or more errors with the general components, in accordance with various embodiments.

FIG. 4 is an exemplary user interface with a notification status of one or more errors. In various embodiments, the user interface may include options to navigate to a status notification page (as set forth in FIGS. 1-3) or an incidents page, in accordance with various embodiments. As shown in FIG. 4, the status on the dashboard may include Inflight Connectivity (IFC) information such as disconnected, impaired or connected. In various embodiments, the component may include a hyperlink to the provider of the component. The user may select the link to go to the provider's website to obtain more information about the problem (e.g., outage, slow down, etc), the status of the problem, the geographical scope of the problem and/or the timing for potential resolution of the problem. The provider may provide a feed of data to the Notification module. Using the provider feed, such additional information may also be incorporated and available within the notification (without having to link to the provider). The Notifications module 510 may notify users of a problem within seconds or minutes (compared to 30 minutes or more with prior systems that would email or call customers).

In various embodiments, the Notifications module 510 may send an audio notification or a visual notification. With reference to FIGS. 1-3, the visual notification may be changing of a graphic to a different color (e.g., from green to red). The user may select the red graphic to obtain more details about the status issues or problems. In various embodiments, the visual notification may also include a pop-up 402 of the notification (e.g., as shown in FIG. 4) in the foreground or background. The External User 545 or Internal User 540 may subscribe or unsubscribe for background notifications. The background notifications provide the pop-up notification to the user, even when the user application or webpage is closed. The Browser Notifications Service 525 may query the user web browser, without the user needing to have the browser open.

When the user enables background notifications, the web application console 520 installs a service worker in the user's browser. The web application console 520 may also send the user's browser notification details to the Notifications module 510. Notifications module 510 may store the user's browser notification details in Database 530. In response to a status change, the Notifications module 510 receives a trigger from Status Gatherer 505. In various embodiments, notifications module 510 may send an event to all users that registered for background notifications. The service worker (now in the user browser) may handle the message, filter out irrelevant status changes based on the user and display a browser notification. The browser notification is displayed if the user's browser is open, but the web application console 520 does not need to be open.

The foreground notifications may provide the pop-up notification to the user within the browser window, when the webpage is open (e.g., FIG. 4) which provides access to web application console 520. The foreground notifications may be considered less intrusive. More particularly, in various embodiments, in response to a change in status check data, the Status Gatherer 505 may send a trigger to the Notifications module 510. The Notifications module 510 may gather a list of all users that requested a notification from the web application console 520. The web application console 520 may create a browser notification. web application console 520 filters out any unrelated status changes, prior to triggering any notifications or displaying any changes on the user interface. For example, web application console 520 may remove any business aviation notifications for any commercial aviation customers. After the filtering, web application console 520 sends the notification to the relevant users based on the filtering.

In various embodiments, the notification process may use tokens. When a user signs up for notifications, a user browser token may be created and stored for that user. The token may be browser specific. For example, Chrome has a Chrome token and Firefox has a Firefox token. The user browser token may be stored in a Database 530 storage service (e.g., Snowflake). The Notifications module 510 may obtain the token for each user from the Database 530 storage. The Notifications module 510 may send the token and the notification to the user browser. The user browser may use the token to allow the notification to be provided via a pop-up in the browser.

The user interface may include a self-service web portal available to Internal Users 540 or External Users 545. The user interface may include a notice (e.g., text and/or audible) or graphic (e.g., toolbar, icon, etc.) that indicates if all (or any subset) of the systems are functioning properly or not (fully or partially) functioning properly. The administrator may adjust the type of data that is provided (or viewable) to all users or certain users. The administrator may filter or obfuscate a subset of the data to only show certain user data. The dashboard may indicate that a component (database) has a problem, but the dashboard may not disclose the specific datasets, the type of database and/or what is happening internally to try to fix the problem. The administrator may switch between different user data. In that regard, the user interface may be user specific to one or more users. For example, users associated with Delta Airlines may only see Delta Airlines data.

The user interface may include, for an example of an airline's user, a flight map showing a graphic of a location of each of the one or more airplanes, along with a color indicator that represents the status of certain components and/or the status of the connectivity of each airplane. The user interface may also include a service intelligence feature that provides service level summaries. The service level summaries may include data or graphs representing Service Availability Distribution, Minimum Data Rate Distribution, Service Availability by Date, a comparison of percent service availability to the percent promised in the service level agreement, or compliance with contract service level agreements. A real time flight status page may provide information for all (or any subset of) active flights. The flights status page provides health of the hardware on the aircraft, health of the services, connectivity information (e.g., satellite), and current user count. Such information may be important to certain users because some users have a Network Operations Center (NOC) that need all systems operating all the time. As such, the NOC needs to quickly know if a system is not functioning correctly. From a user relations standpoint, the provider of the system prefers to notify the NOC of any problems before the NOC finds the problem.

The user interface may also include data and graphics about connectivity including, for example, fleet service data (e.g., total flights, online flights, offline flights, zero passenger electronic device (PED) flights, etc.), customer intelligence (e.g., sessions, session counts, estimated passengers, sessions by flight duration, traffic composition, device type, etc.). A zero PED flight is one with service, but no passengers used the service. The service was typically not used because of an undetected issue. Traffic composition may include video, social media, browsing, audio, downloads and other.

In various embodiments, after the Notification module provides a notification of a problem to a user (or another system), the user, another user, or other module or system may perform an action to fix the problem. The other system may automatically and dynamically interface with the component to analyze the problem, and/or fix (patch or mitigate) the problem. The other system may wait for a certain period of time (e.g., 5 minutes) to determine if the component may correct or fix itself. The Notification 510 module (or any other module) may trigger an on-call alert to request that a third party or another system fix the problem. The Notification 510 module may alert a third party to take action, if the third party system is impacted. For example, data may be hosted at a third-party platform (e.g., data warehousing service), so the Notification 510 module may not have any control over the third party platform. Moreover, the third-party platform may notify the Notification 510 module that the third party platform is having problems, then the Notification 510 module can notify the users about the third party problems. The system may automatically check other systems that may be impacted by the problem component to determine if the other systems have been impacted by the problem component. The system may automatically re-route data or services to a back-up component or a third-party component, in response to a component having problems. The system may automatically increase capacity on a second component or second system, in response to a component having problems. The system may monitor the uptime and/or downtime of certain components, so that the system may automatically track compliance with the requirements and obligations of a service level agreement (SLA). As such, the system operates proactively to inform users of the problem, confirm that the system is aware of the problem and indicate that the system may already be handling the issues.

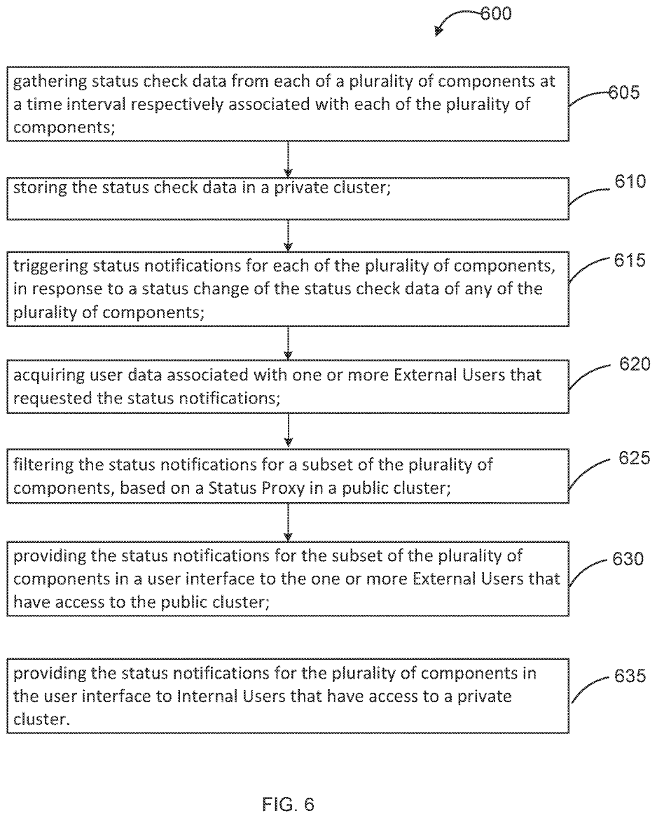

In various embodiments, as set forth in FIG. 6, an exemplary method may include gathering status check data from each of a plurality of components at a time interval respectively associated with each of the plurality of components (step 605); storing the status check data in a private cluster (step 610); triggering status notifications for each of the plurality of components, in response to a status change of the status check data of any of the plurality of components (step 615); acquiring user data associated with one or more External Users 545 that requested the status notifications (step 620); filtering the status notifications for a subset of the plurality of components, based on a Status Proxy in a public cluster (step 625); providing the status notifications for the subset of the plurality of components in a user interface to the one or more External Users 545 that have access to the public cluster (step 630); and providing the status notifications for the plurality of components in the user interface to Internal Users 540 that have access to a private cluster (step 635).

In various embodiments, the storing the status check data may further comprise caching and synchronizing the status check data. In various embodiments, the providing the status notifications to the one or more External Users 545 may further comprise creating one or more user browser tokens respectively for the one or more External Users 545, in response to the one or more External Users 545 requesting the status notification; storing the one or more user browser tokens in a cloud database; obtaining the one or more user browser tokens from the cloud database; and transmitting the one or more user browser tokens respectively to a browser associated with the one or more External Users 545, wherein the browser allows the status notifications to be included in a pop-up window on the user interface.

In various embodiments, the providing the status notifications to the one or more External Users 545 may include providing the status notifications as background status notifications to the one or more External Users 545 that registered for the background status notification, wherein the background status notifications appear regardless of an app being open. The background status notifications may be browser notifications. The method may further comprise installing a service worker configured to provide the status notifications as the background status notifications. The method may further comprise filtering the status changes to include the status changes that are relevant to the one or more External Users 545. The method may further comprise handling HTTP requests using a display thread. The method may further comprise reading the status check data in storage and new incidents in storage, prior to displaying the status check data and the new incidents, in response to HTTP requests. The gathering the status check data may use one or more status check threads.

In various embodiments, the method may further comprise checking, after the time interval, if each of the plurality of components should run a status check based on a respective last check timestamp on each of the plurality of components. The method may further comprise updating a last check timestamp on each of the plurality of components, in response to running a status check on a respective each of the plurality of components. The providing the user interface may be in response to the one or more External Users 545within the public cluster having subscriptions for the user interface. The user interface may include the status notifications obtained from the private cluster. The storing the status check data in the private cluster may include storing the status check data in a Remote Server and in a cloud server for long term storage. The providing the status notifications to the one or more External Users 545 may include providing the status notifications in a foreground browser notification, in response to the one or more External Users 545 having an app open. Each of the status notifications may include a navigation option to access a status page. Each of the status notifications may include a navigation option to access an incidents page.

In various embodiments, the health and status check data may be in a non-standardized format. For example, an algorithm may not be able to read or compare the health and status check data because the health and status check data may be from different components that process and/or store data differently, or that use a different process or interface for providing health and status. To enable the algorithm to analyze the health and status check data, in various embodiments, the system may convert such health and status check data to a standardized format, such that the system is able to compare the different health and status check data from the different components. The system may allow users to access data (e.g., health and status check data, etc), and receive updated data in real time. The system may store the health and status check data (e.g., in a non-standardized format) in one or more storage devices (e.g., 530, 535), provide remote access over a network so that users or the system may update the data that is in a non-standardized format (e.g., dependent on the hardware and software platform used by the components) in real time through a GUI. The system may convert the updated data that was input in a non-standardized form to the standardized format, automatically generate a notification (e.g., containing the updated health and status check data) whenever the updated data is stored and transmit the notification to the users over a computer network in real time, so that the user has immediate access to the up-to-date data (e.g., the latest health and status check data). The system allows remote users to share data in real time in a standardized format, regardless of the format (e.g., non-standardized) that the information was input.

In various embodiments, the system may include the unconventional and non-generic combination of known components by including a filtering tool that is remote from the end user and provides customizable filtering features to each end user. The filtering tool may provide customizable filtering by filtering access to the data. The filtering tool may identify customer data or customer accounts that communicate with the server and may associate a request for content with the individual account. The system may include a filter on a local computer and a filter on a server. The filtering tool may identify information or accounts that communicate with the server, and associate a request for content with the individual account.

In various embodiments, the system may move the most used icons or indicators (or the indicators experiencing the most outages) to a position on the GUI, specifically close to the top of the status list. The use may be determined over a period of time by tracking the number of times the indicator or component is selected or how much memory is allocated to the indicator or component. The user may also manually enter which component or indicator is used more often.

In various embodiments, the system may train a model, obtain results, then use the results to enhance the model. More specifically, in various embodiments, the system may use an expanded data set of past data or a subset of text replies to train a neural network. The expanded training set may be developed by applying mathematical algorithms to the acquired set of data. The neural network may then be trained with the expanded data set using a machine learning algorithm that, for example, may use a mathematical function to adjust certain weighting. The system may also use an iterative training algorithm to re-train with additional data (e.g., health and status check data).

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of outages over time, from web registrations, from social media, from internal data, or from other suitable sources. Big data sets may be compiled without descriptive metadata such as column types, counts, percentiles, or other interpretive-aid data points.

Association of certain data may be accomplished through any desired data association technique. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with various embodiments, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, airline, merchant, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the component along with the associated data, but instead the appropriate action may be taken by providing to the user, at the standalone device, the appropriate option for the action to be taken. The system may contemplate a data storage arrangement wherein the header or trailer, or header or trailer history, of the data is stored on the system, device or component in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g. IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® OS® operating systems, etc.) as well as various conventional support software and drivers typically associated with computers. The web-client may also run MICROSOFT® INTERNET EXPLORER® software, MOZILLA FIREFOX® software, GOOGLE CHROME™ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

Any of the communications, inputs, storage, databases or displays discussed herein may be facilitated through a website having web pages. The term “web page” as it is used herein is not meant to limit the type of documents 340 and applications that might be used to interact with the user. For example, a typical website might include, in addition to standard HTML documents 340, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communication means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

Any communication, transmission, and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV@, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT®, SNAPCHAT®, WHATSAPP®, FLICKR®, VK®, QZONE®, WECHAT®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE@ iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a reply from the operating system which monitors various hardware components and then communicates a detected input from the hardware to the micro-app.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a reply from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE. JS® components. NODE. JS® programs may implement several modules to handle various core functionalities. For example, a package management module, such as NPM®, may be implemented as an open source library to aid in organizing the installation and management of third-party NODE. JS® programs. NODE. JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, NY) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
gathering, by a processor, status check data from each of a plurality of components at a time interval respectively associated with each of the plurality of components;
storing, by the processor, the status check data in a private cluster of modules,
wherein the private cluster of modules is not publicly accessible, but the private cluster data is accessible by one or more External Users that have private access via a virtual private network (VPN), through a status proxy module or through a web application console, and;
wherein the one or more External Users operate the plurality of components;
triggering, by the processor, status notifications for each of the plurality of components, in response to a status change of the status check data of any of the plurality of components;
acquiring, by the processor, user data associated with one or more External Users that requested the status notifications,
wherein the one or more External Users are different users from Internal Users;
filtering, by the processor, the status notifications for a subset of the plurality of components, based on a Status Proxy in a public cluster of modules,
wherein the public cluster of modules is accessible via an internet;
providing, by the processor, the status notifications for the subset of the plurality of components in a user interface to the one or more External Users that have access to the public cluster of modules,
providing, by the processor, the status notifications for a second of the subset of the plurality of components in the user interface to the one or more External Users that have access to the private cluster of modules,
wherein the one or more External Users access the private cluster of modules through at least one of the virtual private network (VPN), the Status Proxy or the web application console; and
providing, by the processor, the status notifications for the plurality of components in the user interface to the Internal Users that have access to the private cluster of modules,
wherein the Internal Users include a system administrator that controls the modules and monitors the plurality of components.

2. The method of claim 1, wherein the storing the status check data further comprises storing the status check data into a common data structure to reduce database synchronization errors between different databases and to improve integrity of the status check data ..

3. The method of claim 1, wherein the providing the status notifications to the one or more External Users further comprises:
creating, by the processor, one or more user browser tokens respectively for the one or more External Users, in response to the one or more External Users requesting the status notifications;
storing, by the processor, the one or more user browser tokens in a cloud database;
obtaining, by the processor, the one or more user browser tokens from the cloud database; and
transmitting, by the processor, the one or more user browser tokens respectively to a browser associated with the one or more External Users,
wherein the browser allows the status notifications to be included in a pop-up window on the user interface.

4. The method of claim 1, wherein the providing the status notifications to the one or more External Users includes providing the status notifications as a background status notifications to the one or more External Users that registered for the background status notifications, wherein the background status notifications appear regardless of an app being open.

5. The method of claim 4, wherein the background status notifications are browser notifications.

6. The method of claim 4, further comprising installing a service worker configured to provide the status notifications as the background status notifications.

7. The method of claim 1, further comprising filtering, by the processor, the status changes to include the status changes that are relevant to the one or more External Users.

8. The method of claim 1, further comprising handling, by the processor, HTTP requests using a display thread.

9. The method of claim 1, further comprising reading, by the processor, the status check data in storage and new incidents in storage, prior to displaying the status check data and the new incidents, in response to HTTP requests.

10. The method of claim 1, wherein the gathering the status check data uses one or more status check threads.

11. The method of claim 1, one further comprising checking, by the processor and after the time interval, if each of the plurality of components should run a status check based on a respective last check timestamp on each of the plurality of components.

12. The method of claim 1, further comprising updating, by the processor, a last check timestamp on each of the plurality of components, in response to running a status check on a respective each of the plurality of components.

13. The method of claim 1, wherein the providing the user interface is in response to the one or more External Users within the public cluster of modules having subscriptions for the user interface.

14. The method of claim 1, wherein the user interface includes the status notifications obtained from the private cluster of modules using JSON.

15. The method of claim 1, wherein the storing the status check data in the private cluster of modules includes storing the status check data in a Remote Server and in a cloud server for long term storage.

16. The method of claim 1, wherein the providing the status notifications to the one or more External Users includes providing the status notifications in a foreground browser notification, in response to the one or more External Users having an app open.

17. The method of claim 1, wherein each of the status notifications include a navigation option to access a status page.

18. The method of claim 1, wherein each of the status notifications include a navigation option to access an incidents page.

19. A non-transitory, tangible computer readable storage medium having instructions stored thereon that, in response to execution by a processor, cause the processor to perform operations comprising:
gathering, by the processor, status check data from each of a plurality of components at a time interval respectively associated with each of the plurality of components;
storing, by the processor, the status check data in a private cluster of modules,
wherein the private cluster of modules is not publicly accessible, but the private cluster data is accessible by one or more External Users that have private access via a virtual private network (VPN), through a status proxy module or through a web application console, and;
wherein the one or more External Users operate the plurality of components;
triggering, by the processor, status notifications for each of the plurality of components, in response to a status change of the status check data of any of the plurality of components;
acquiring, by the processor, user data associated with one or more External Users that requested the status notifications,
wherein the one or more External Users are different users from Internal Users;
filtering, by the one or more processors, the status notifications for the subset of the plurality of components, based on a Status Proxy in a public cluster of modules,
wherein the public cluster of modules is accessible via an internet;
providing, by the processor, the status notifications for a first of the subset of the plurality of components in a user interface to the one or more External Users that have access to the public cluster of modules,
providing, by the processor, the status notifications for a second of the subset of the plurality of components in the user interface to the one or more External Users that have access to the private cluster of modules,
wherein the one or more External Users access the private cluster of modules through at least one of the virtual private network (VPN), the Status Proxy or the web application console; and
providing, by the processor, the status notifications for the plurality of components in the user interface to the Internal Users that have access to the private cluster of modules,
wherein the Internal Users include a system administrator that controls the modules and monitors the plurality of components.

20. A system comprising:
a processor; and
a tangible, non-transitory memory configured to communicate with the processor,
the tangible, non-transitory memory having instructions stored thereon that, in response to execution by the processor, cause the processor to perform operations comprising:
gathering, by the processor, status check data from each of a plurality of components at a time interval respectively associated with each of the plurality of components;
storing, by the processor, the status check data in a private cluster of modules,
wherein the private cluster of modules is not publicly accessible, but the private cluster data is accessible by one or more External Users that have private access via a virtual private network (VPN), through a status proxy module or through a web application console, and;
wherein the one or more External Users operate the plurality of components;
triggering, by the processor, status notifications for each of the plurality of components, in response to a status change of the status check data of any of the plurality of components;
acquiring, by the processor, user data associated with the one or more External Users that requested the status notifications,
wherein the one or more External Users are different users from Internal Users;
filtering, by the processor, the status notifications for a subset of the plurality of components, based on a Status Proxy in a public cluster of modules, wherein the public cluster of modules is accessible via an internet;
providing, by the processor, the status notifications for a first of the subset of the plurality of components in a user interface to the one or more External Users that have access to the public cluster of modules,
providing, by the processor, the status notifications for a second of the subset of the plurality of components in the user interface to the one or more External Users that have access to the private cluster of modules,
wherein the one or more External Users access the private cluster of modules through at least one of the virtual private network (VPN), the Status Proxy or the web application console; and
providing, by the processor, the status notifications for the plurality of components in the user interface to the Internal Users that have access to the private cluster of modules,
wherein the Internal Users include a system administrator that controls the modules and monitors the plurality of components.
